(19) United States
(12) Patent Application Publication
(10) Pub. No.: US 2007/0103095 A1
(43) Pub. Date: May 10, 2007

(54) SWITCHING LED DRIVER WITH TEMPERATURE COMPENSATION TO PROGRAM LED CURRENT

(76) Inventor: Ta-Yung Yang, Milpitas, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/268,536

(22) Filed: Nov. 8, 2005

(51) Int. Cl. H05B 39/00

(52) U.S. Cl. 315/312

(57) ABSTRACT

The present invention provides a LED driver for control the brightness of the LED. An energy-transferred element and a switch are connected in series with the LED for controlling the current of the LED. A diode is coupled to the energy-transferred element for freewheeling the energy of the energy-transferred element through the LED. A control circuit is developed to generate a control signal for switching the switch in response to the LED current. The LED current is further adjusted in response to a voltage signal of the LED. The value of the voltage signal is correlated to the LED temperature. Therefore the LED current can be programmed in accordance with the LED temperature.

### BACKGROUND OF THE INVENTION

1. Field of Invention

The present invention relates to a LED (light emission diode) driver, and more particularly to a control circuit for controlling the LED.

2. Description of Related Art

The LED driver is utilized to control the brightness of LED in accordance with its characteristics. The LED driver is utilized to control the current that flows through the LED. A higher current increases the intensity of the brightness, but decreases the life of the LED. FIG. 1 shows a traditional circuit of the LED driver. The voltage source 10 is adjusted to provide a current I_{LED} to the LEDs 20˜25 through a resistor 15. The current I_{LED} can be shown as equation (1):

$${I}_{LED} = \frac{V - {V}_{F 20} - {V}_{F 21} - … - {V}_{F 25}}{{R}_{15}} \qquad ( 1 )$$

wherein the V_{F20}˜V_{F25} are the forward voltage of the LEDs 20˜25 respectively.

The drawback of the LED driver shown in FIG. 1 is the variation of the current I_{LED}. The current I_{LED} is changed in response to the change of the forward voltages of V_{F20}˜V_{F25}. The forward voltages of V_{F20}˜V_{F25} are not a constant due to the variation of the production and operating temperature. The second drawback of the LED driver shown in FIG. 1 is the power loss occurred on the resistor 15.

FIG. 2 shows another traditional approach of the LED driver. A current source 35 is connected in series with the LEDs 20˜25 to provide a constant current to the LEDs 20˜25. However, the disadvantage of this circuit is the power loss of the current source 35, particularly, as the voltage source 30 is high and the LED voltage drops of V_{F20}˜V_{F25} are low. Besides, a chromaticity and a luminosity of the LED are affected by the change of the LED's operating temperature. In order to keep the chromaticity and/or the luminosity of the LED as a constant, the current of the LED should be adjusted in response to the change of the temperature. The major objective of the present invention is to provide a LED driver to achieve a higher efficiency. The second objective of the present invention is to develop a LED driver capable of compensating the influence of the temperature.

### SUMMARY OF THE INVENTION

The present invention provides a switching LED driver to control the brightness of the LED. The LED driver comprises a magnetic device such as an energy-transferred element connected in series with the LED, and a switch is coupled in series to the LED and the energy-transferred element for controlling a LED current. A control circuit is coupled to generate a control signal in response to a voltage signal of the LED and the LED current. A first resistor is connected in series with the LED to sense the LED current and generate a LED current signal coupled to the control circuit. A diode is coupled to the LED and the energy-transferred element for discharging the energy of the energy-transferred element through the LED. The control signal is utilized to control the switch and the LED current. Therefore the switch is turned off once the LED current is higher than a first threshold, and the switch is turned on after a period of a programmable delay time once the LED current is lower than a second threshold. Besides, the first threshold is varied in response to the voltage signal of the LED. The value of the voltage signal shows a LED forward voltage that is correlated to the LED temperature. Therefore the LED current can be programmed to compensate the chromaticity and the luminosity variations in accordance with the LED temperature.

### BRIEF DESCRIPTION OF ACCOMPANIED DRAWINGS

The accompanying drawings are included to provide a further understanding of the present invention, and are incorporated in and constitute a part of this specification. The drawings illustrate embodiments of the present invention and, together with the description, serve to explain the principles of the present invention. In the drawings,

FIG. 1 shows a traditional LED driver;

FIG. 2 shows another traditional LED driver;

FIG. 3 shows a switching LED driver in accordance with present invention;

FIGS. 4A and 4B shows a LED current waveforms in accordance with present invention;

FIG. 5 shows a control circuit of the switching LED driver in accordance with present invention;

FIG. 6 shows a delay circuit that controls the brightness of LED in accordance with present invention;

FIG. 7 shows a sample circuit of the control circuit in accordance with present invention;

FIG. 8 shows signal waveforms of the control circuit in accordance with present invention; and

FIG. 9 shows a current adjust circuit in accordance with present invention.

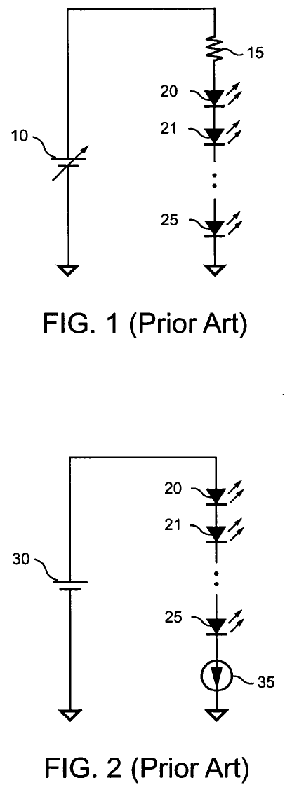

### DESCRIPTION OF THE PREFERRED EMBODIMENT

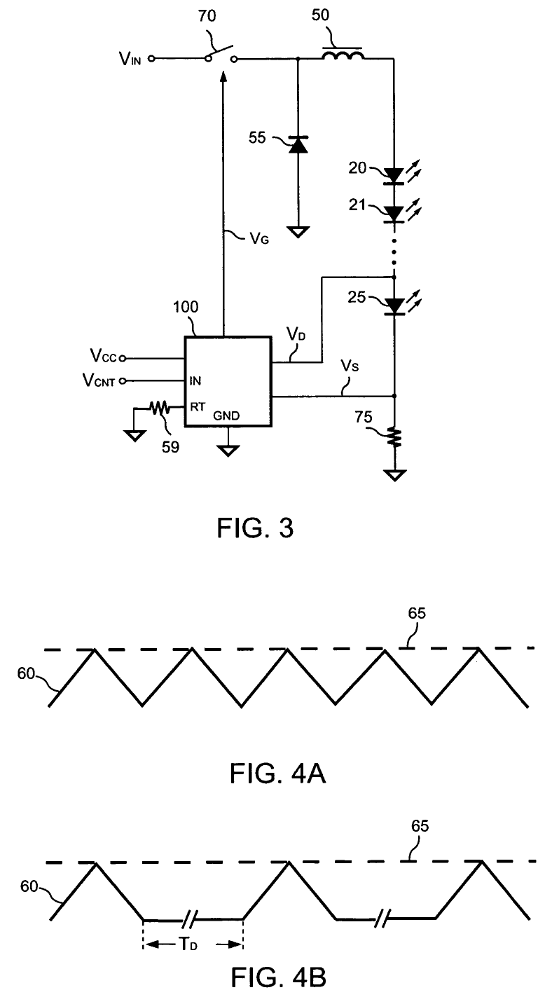

FIG. 3 shows a switching LED driver in accordance with present invention, in which an energy-transferred element 50 is coupled in series with the LEDs 20˜25. A switch 70 is coupled in series to the LEDs 20˜25 and the energy-transferred element 50 for controlling the LED current. Through a first resistor 75, the LED current is further converted to a current signal V_{S} coupling to a control circuit 100. The control circuit 100 is further coupled to the LED to receive a voltage signal of the LED. A diode 55 is coupled to the LEDs 20˜25 and the energy-transferred element 50. Once the switch 70 is turned off, the energy of the energy-transferred element 50 is discharged through the LEDs 20˜25 and the diode 55. Meanwhile the control circuit 100 detects the forward voltage of the LED. The forward voltage of the LED is decreased in proportion to the increase of the LED temperature. Accordingly the voltage signal of the LED shows the variation of the LED temperature. For limiting the LED current, the switch 70 is turned off once the LED current is higher than a first threshold V_{R}. The maximum LED current can be expressed as equation (2):

$${I}_{LED ( MAX )} = \frac{{V}_{IN} - {V}_{F 20} - … - {V}_{F 25}}{{L}_{50}} \times {T}_{ON} \qquad ( 2 )$$

where the L₅₀ is the inductance of the energy-transferred element 50; T_{ON} is the on time of the switch 70.

FIGS. 4A and 4B show the LED current waveform 60, in which the maximum value 65 of the first threshold V_{R} limits the peak value of the LED current. The switch 70 is turned on to enable the LED current in response to the current signal V_{S} is lower than a second threshold V_{TH}. The LED current is thus controlled as a triangle waveform. The maximum value 65 of the first threshold V_{R} determines the average value of the LED current. Consequently the average value of the LED current is controlled as a constant despite the inductance variation of the energy-transferred element 50. Furthermore, the time delay T_{D} is programmed to control value of the LED current and the brightness of the LEDs 20˜25.

The control circuit 100 is utilized to generate a control signal V_{G} to control the switch 70 and the LED current in response the LED current and the voltage signal of the LED. In order to keep the chromaticity and the luminosity of the LED as a constant, the LED current should be adjusted in reference to the LED temperature. According to present invention, the first threshold V_{R} and the voltage signal of the LED are correlated to the LED current and the LED temperature respectively. The first threshold V_{R} is controlled and varied in response to the voltage signal of the LED for the chromaticity and the luminosity compensation. Furthermore, for adapting various LEDs, a second resistor 59 is coupled to the control circuit 100 to determine the slope of the adjustment. The slope stands for ‘the change of the first threshold V_{R} ’ versus ‘the change of the voltage signal of the LED’.

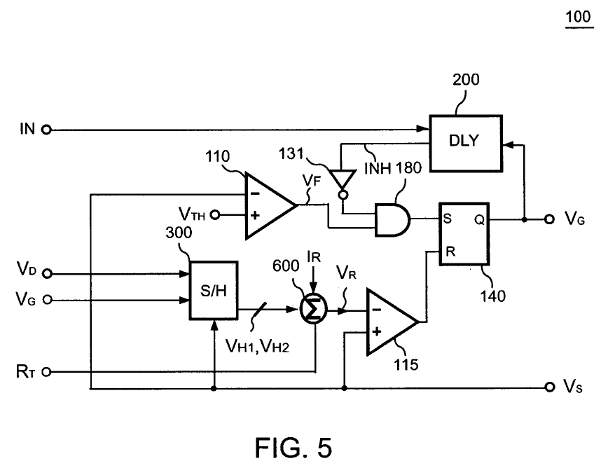

FIG. 5 shows a circuit schematic of the control circuit 100. The first threshold V_{R} is coupled to turn off the control signal V_{G} once the current signal V_{S} is higher than the first threshold V_{R}. An enable signal V_{F} is coupled to turn on the control signal V_{G} once the current signal V_{S} is lower than the second threshold V_{TH}. The voltage signal V_{D} is produced by the voltage signal of the LED. A first control circuit including an AND gate 180, an inverter 131 and a flip-flop 140 generate the control signal V_{G} in response to a delay signal INH and the enable signal V_{F}. The output of the AND gate 180 is connected to enable the flip-flop 140. The control signal V_{G} is generated at the output of the flip-flop 140. A second control circuit 115 is applied to disable the control signal V_{G} once the current signal V_{S} is higher than the first threshold V_{R}. The output of the second control circuit 115 is connected to disable the flip-flop 140. A delay circuit 200 generates the delay signal INH having the time delay T_{D} in response to the off-state of the control signal V_{G}. The delay signal INH is connected to the input of the AND gate 180 through the inverter 131. The control signal V_{G} is disabled during the period of the time delay T_{D}. A sample circuit 300 is coupled to sample the voltage signal V_{D} and generate a first-sampled signal V_{H1} and a second-sampled signal V_{H2}. A constant current I_{R} is supplied to a current adjust circuit 600 to generate the first threshold V_{R}. The first-sampled signal V_{H1} and the second-sampled signal V_{H2} are connected to the current adjust circuit 600 to program the value of the first threshold V_{R}. A comparison circuit 110 is applied to produce the enable signal V_{F} once the current signal V_{S} is lower than a second threshold V_{TH}. The enable signal V_{F} is connected to the input of the AND gate 180 enabling the control signal V_{G}.

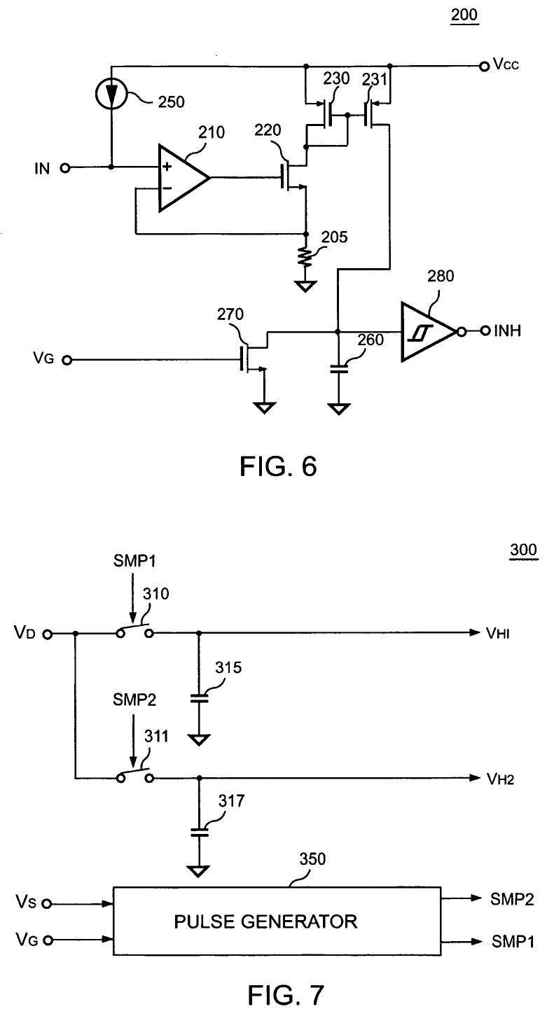

FIG. 6 shows the delay circuit 200 that controls the brightness of the LED. A constant current source 250 is connected to an input terminal IN of the control circuit 100. The input terminal IN is developed to program the brightness of the LED. A resistor connected from the input terminal IN to ground and/or a control voltage V_{CNT} connected to the input terminal IN will program the value of the time delay T_{D}. A operational amplifier 210, a resistor 205, transistors 220, 230 and 231 form a voltage-to-current converter for generating a charge current at transistor 231 in reference to the voltage at the input terminal IN. A transistor 270 is connected to discharge a capacitor 260. The input of the transistor 270 is connected to the control signal V_{G}. The charge current is coupled to charge the capacitor 260 in response to the off-state of the control signal V_{G}. The input of in inverter 280 is connected to the capacitor 260. The output of the inverter 280 generates the delay signal INH.

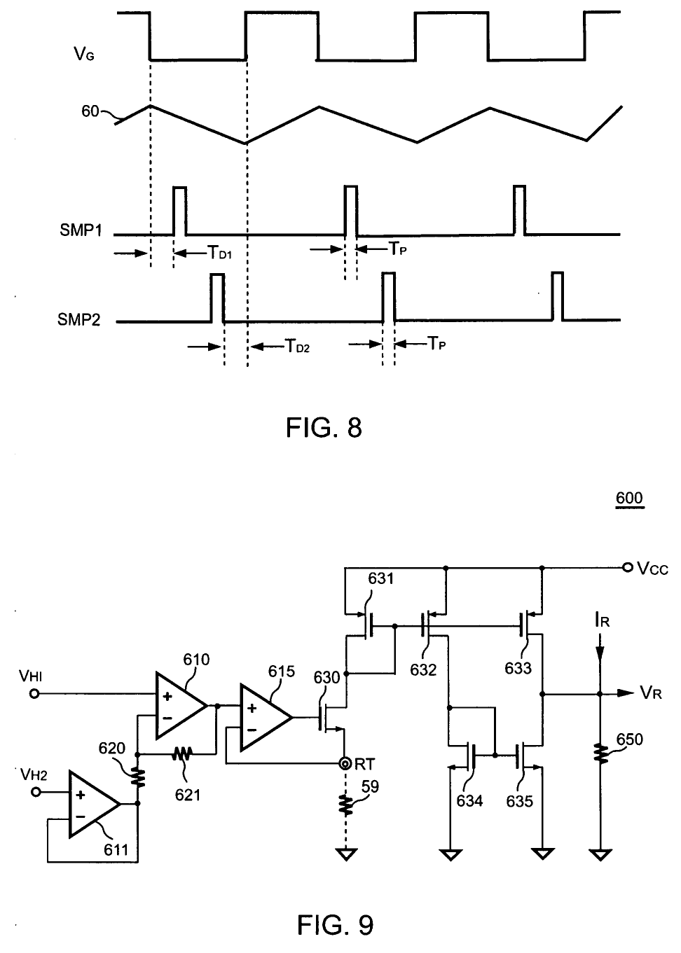

FIG. 7 shows the sample circuit 300 of the control circuit 100. A pulse generator 350 generates a first pulse SMP1 and a second pulse SMP2 in response to the current signal Vₛ, the off-state of the control signal V_{G} and the voltage signal V_{D}. FIG. 8 shows the signal waveforms, in which the first pulse SMP1 is produced after the control signal V_{G} is in off-state. A delay time T_{D1} ensures that the voltage signal V_{D} is stable before enabling of the first pulse SMP1. A delay time T_{D2} ensures that the second pulse SMP2 is produced before the current signal V_{S} falling to zero. The first pulse SMP1 and the second pulse SMP2 are coupled to control the on/off-state of a switch 310 and a switch 311. The switch 310 and the switch 311 are coupled to sample the voltage signal V_{D} and generate the first-sampled signal V_{H1} and the second-sampled signal V_{H2} on capacitors 315 and 317 respectively. Therefore the first-sampled signal V_{H1} and the second-sampled signal V_{H2} represent a first forward voltage of the LED and a second forward voltage of the LED in response to a first LED current I₁ and a second LED current I₂ respectively.

The current adjust circuit 600 is shown in FIG. 9. Operational amplifiers 610, 611 and resistors 620, 621 develop a differential circuit. The first-sampled signal VH1 and the second-sampled signal V_{H2} are connected to the differential circuit. The differential value of the first-sampled signal V_{H1} and the second-sampled signal V_{H2} is produced at the output of the operational amplifier 610. The output of the operational amplifier 610 is further coupled to the input of an operational amplifier 615. The operational amplifier 615, transistors 630˜635 and the resistor 650 form another voltage-to-current converter to generate currents I₆₃₃ and I₆₃₅ in proportion to the resistance of the resistor 59 and the differential value of the first-sampled signal V_{H1} and the second-sampled signal V_{H2}. A resistor 650 associated with the constant current I_{R} generate the first threshold VR. The current I₆₃₃ and the current I₆₃₅ are connected to the resistor 650 to adjust the first threshold VR. The first-sampled signal V_{H1} and the second-sampled signal V_{H2} correspond to the first forward voltage V₁ and the second forward voltage V₂.

The first forward voltage V₁ and the second forward voltage V₂ correspond to the first LED current I₁and the second LED current I₂. The current I₁ and I₂ are given by equation (3) and (4):
I1=I0×e^{V1/VT} (3)
I2=I0×e^{V2/VT} (4)

where

$$V T = \frac{k \times Temp}{q} ;$$

k is the Boltzmann's constant; q is the charge on an electron; and Tₑₘₚ is the absolute temperature. More, Tₑₘₚ is shown as equation (5):

$$Temp = \frac{q}{k} \times \frac{{V}_{1} - {V}_{2}}{ln ( \frac{{I}_{1}}{{I}_{2}} )} \qquad ( 5 )$$

Forgoing equations show the LED temperature can be accurately detected from the voltage signal V_{D}. The LED temperature is further used for programming the LED current and compensating the chromaticity and the luminosity of the LED.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A LED driver comprising:
an energy-transferred element, connected in series with a LED;
a switch, coupled in series to the LED and the energy-transferred element for controlling a LED current;
a control circuit, generating a control signal in response to a voltage signal of the LED and the LED current;
a diode, coupled to the LED and the energy-transferred element for discharging the energy of the energy-transferred element through the LED;
a first resistor, connected in series with the LED to sense the LED current and generate a LED current signal coupled to the control circuit; and
a second resistor, connected to the control circuit to determine a slope of the adjustment, in which the slope represents the change of a first threshold versus the change of the LED current of the LED;
wherein the control signal is used to control the switch and the LED current, wherein the switch is turned off once the LED current is higher than the first threshold, and the first threshold is varied in response to the voltage signal of the LED, and the switch is turned on after a period of a programmable delay time once the LED current is lower than a second threshold.

2. The LED driver as claimed in claim 1, the control circuit comprising:
a first control circuit, enabling the control signal in response to a delay signal and an enable signal;
a second control circuit, disabling the control signal once the LED current signal is higher than the first threshold;
a comparison circuit, producing the enable signal once the LED current signal is lower than the second threshold;
a delay circuit, generating the delay signal having the programmable delay time in response to the off-state of the control signal, in which the control signal is disabled during the period of the programmable delay time; and
a sample circuit, generating a first-sampled signal and a second-sampled signal in response to the voltage signal of the LED;
wherein the first-sampled signal and the second-sampled signal are used to adjust the first threshold.

3. The LED driver as claimed in claim 2, wherein the first-sampled signal and the second-sampled signal represent a first forward voltage of the LED and a second forward voltage of the LED in response to a first LED current and a second LED current respectively.

4. A LED driver comprising:
an energy-transferred element, connected in series with a LED;
a switch, coupled in series to the LED and the energy-transferred element for controlling a LED current;
a control circuit, generating a control signal in response to a voltage signal of the LED and the LED current;
a diode, coupled to the LED and the energy-transferred element for discharging the energy of the energy-transferred element through the LED; and
a first resistor, connected in series with the LED to sense the LED current and generate a LED current signal coupled to the control circuit;
wherein the control signal is used to control the switch and the LED current, wherein the switch is turned off once the LED current is higher than a first threshold, wherein the switch is turned on after the LED current is lower than a second threshold.

5. The LED driver as claimed in claim 4, wherein the first threshold is varied in response to the voltage signal of the LED.

6. The LED driver as claimed in claim 4, further comprising a second resistor connected to the control circuit to determine a slope of the adjustment, in which the slope represents the change of the first threshold versus the change of the LED current of the LED.

7. The LED driver as claimed in claim 4, the control circuit comprising:
a first control circuit, enabling the control signal in response to a delay signal, and an enable signal;
a second control circuit, disabling the control signal once the LED current signal is higher than the first threshold;
a comparison circuit, producing the enable signal once the LED current signal is lower than the second threshold;
a delay circuit, generating the delay signal having the programmable delay time in response to the off-state of the control signal; and
a sample circuit, generating a first-sampled signal and a second-sampled signal in response to the voltage signal of the LED;
wherein the first-sampled signal and the second-sampled signal are used to adjust the first threshold.

8. The LED driver as claimed in claim 7, wherein the first-sampled signal and the second-sampled signal represent a first forward voltage of the LED and a second forward voltage of the LED in response to a first LED current and a second LED current respectively

9. A LED driver comprising:
an energy-transferred element, connected in series with a LED;
a switch, coupled in series to the LED and the energy-transferred element for controlling a LED current;
a control circuit, generating a control signal in response to a voltage signal of the LED and the LED current; and
a diode, coupled to the LED and the energy-transferred element for discharging the energy of the energy-transferred element through the LED;
wherein the control signal controls the switch and the LED current, wherein the switch is turned off once the LED current is higher than a first threshold.

10. The LED driver as claimed in claim 9, wherein the first threshold is varied in response to the voltage signal of the LED.

11. The LED driver as claimed in claim 9, further comprising:
a first resistor, connected in series with the LED to sense the LED current and generate a LED current signal coupled to the control circuit; and
a second resistor, connected to the control circuit to determine a slope of the adjustment, in which the slope represents the change of the first threshold versus the change of the LED current of the LED.

12. The LED driver as claimed in claim 9, the control circuit comprising:
a first control circuit, enabling the control signal in response to a delay signal, and an enable signal;
a second control circuit, disabling the control signal once the LED current signal is higher than the first threshold;
a comparison circuit, producing the enable signal once the LED current signal is lower than the second threshold;
a delay circuit, generating the delay signal having the programmable delay time in response to the off-state of the control signal; and
a sample circuit, generating a first-sampled signal and a second-sampled signal in response to the voltage signal of the LED;
wherein the first-sampled signal and the second-sampled signal are used to adjust the values of the first threshold.

13. The LED driver as claimed in claim 12, wherein the first-sampled signal and the second-sampled signal represent a first forward voltage of the LED and a second forward voltage of the LED in response to a first LED current and a second LED current respectively.
